(19) United States
(12) Patent Application Publication
(10) Pub. No.: US 2026/0155035 A1
(43) Pub. Date: Jun. 4, 2026

(54) SYSTEM AND METHOD FOR ASSESSING FALSE ALARM TO OPTIMIZE EARLYWARNING OPERATIONS

(71) Applicant: KOREA ELECTRIC POWER CORPORATION, Naju-si (KR)

(72) Inventors: Joon-Seok OH, Daejeon (KR); Jae-Dong KIM, Daegu (KR); Jong-Duk SON, Daejeon (KR); Hee-Soo KIM, Daejeon (KR)

(21) Appl. No.: 19/126,240

(22) PCT Filed: Jul. 14, 2023
(86) PCT No.: PCT/KR2023/010107

§ 371 Date: Apr. 30, 2025

(30) Foreign Application Priority Data
Nov. 1, 2022 (KR) 10-2022-0143636

(51) Int. Cl. G08B 29/18; G06N 20/00; G08B 29/20; G08B 31/00

(52) U.S. Cl. CPC G08B 29/185; G06N 20/00; G08B 29/20; G08B 31/00

(57) ABSTRACT

A system capable of optimizing early alarm operation by introducing an alarm filtering technology so as not to cause false alarm to an abnormal signal due to signal noise is disclosed. The system comprises: a data acquisition unit for selectively acquiring historical data according to the operation of a electric power facility by selecting a preset multivariate input tag; a recommendation unit for generating learning data, which is a multivariate signal for machine learning, based on a preset similarity from the historical data; a compression unit for generating re-sampling data by compressing the learning data; a learning unit for performing real-time monitoring by using the re-sampling data as input data of a pre-designed early warning learning model; and a calculation unit for generating a final warning when a predetermined condition predefined through the real-time monitoring is satisfied.

### TECHNICAL FIELD

### Technical Field

The present invention relates to early warning technology for detecting abnormal signs of a plant in advance, and more particularly, to multivariate signal compression and alarm assessment technology for optimizing early warning operation.

Furthermore, the present invention claims the benefits of Korean Patent Application No. 10-2022-0143636 filed on Nov. 1, 2022, and the entire contents thereof are incorporated herein by reference.

### Background Art

In general, large plants such as power generation or chemistry are operated by intricately connecting hundreds of mechanical and electrical facilities. In order to supply power and products stably, these large plants must always measure abnormal signs that cause accidents to ensure reliability.

Early warning technology is a technology that detects early the trend of a signal changing to an abnormal state outside the trained normal section after learning the normal state pattern of the signal group.

The key part of early warning technology is to accurately extract normal state data, that is, past patterns, based on past history data.

When a prediction model (or learning model) of early warning is generated, if abnormal data such as noises, abnormal signals, and measurement errors due to communication failures are included, the performance of the prediction model is deteriorated, a false alarm is generated, or the early warning is not generated because it does not react sensitively to a problematic signal.

In addition, if all alarms are managed without assessment according to importance or severity even when an alarm occurs, the alarm for an instrument device having a high frequency but a low risk effect, such as a sensor, may miss an alarm for a serious equipment (boiler, turbine, or auxiliary device) defect due to the alarm.

Currently, there is no multivariate signal-based training data compression technology to improve the training model prediction performance and prevent false alarms. In addition, there is no assessment criterion for early warning alarms.

In addition, existing early warning products require a lot of time to manage alarms as a number of alarms are generated without assessing the importance of alarms. In addition, most of the alarms generated are due to an error in a measuring instrument rather than an abnormality in a facility, and the alarms generated without assessment of importance rather increase the burden on the user's work.

In addition, the size of the training data has the greatest influence on the operation of an early warning system, and as the number of training models increases, the burden of software increases and then the process speed of the early warning system slows down. Therefore, users complain of inconvenience or eventually the early warning system becomes shunned by the users.

### DISCLOSURE

### Technical Problem

The present invention is proposed to solve the problems of the background technology, and the purpose of the present invention is to provide a system and a method capable of optimizing early alarm operation by introducing an alarm filtering technology so as not to cause false alarm to be generated in an abnormal signal due to signal noise.

Other object of the present invention is to provide a system and method for including a variability pattern in training data to prevent a false alarm due to variability in a signal in which a state of an electric power facility changes (before and after maintenance, seasonal changes, etc.).

Another object of the present invention is to provide a system and a method for easily determining and managing an alarm having a high priority after assessing a severity grade for an alarm generated by applying assessment criteria according to strength and continuity to an alarm of various conditions generated in an early warning.

### Technical Solution

In order to achieve the objects presented above, the present invention provides a system capable of optimizing early alarm operation by introducing an alarm filtering technology so as not to cause false alarm to an abnormal signal due to signal noise.

The system comprises: a data acquisition unit for selectively acquiring historical data stored in a database among operation data of a constant electric power facility according to selection of a multivariate input tag measured in the electric power facility; a recommendation unit for generating learning data, which is a multivariate signal for machine learning, based on a preset similarity from the historical data; a compression unit for compressing the learning data to generate re-sampling data; a learning unit for performing real-time monitoring by using the re-sampling data as input data of a pre-designed early warning learning model; and a calculation unit for generating a final warning when a condition predefined through the real-time monitoring is satisfied.

In this case, the calculation unit monitors a residual value that is a difference between a predicted value calculated through the early warning learning model and an actual value, and calculates a final residual value by primarily filtering the residual value, and generates the final alarm using the final residual value.

In addition, when an alarm is generated because the filtered residual value is greater than or equal to a preset threshold value, the calculation unit assesses an alarm grade according to a predefined strength condition and a predefined continuity condition, and generates only an alarm equal to or greater than the defined condition as the final alarm.

In addition, the strength condition is a criterion for assessing how many times or more of a preset threshold is exceeded, and the continuity condition is a criterion for assessing how many times or more of the data observed in real time exceeds the same strength grade (multiple of the same threshold).

The calculation unit may generate an alarm code when the intensity condition and the continuity condition are satisfied, and generate a rule for determining a severity grade based on the alarm code.

In addition, the calculation unit determines whether the rule corresponds to a preset rule correction condition, and newly creates or corrects the rule according to the determination result.

The calculation unit may extract the re-sampling data by compressing the training data in a scaling down or equidistant intervals.

In addition, the compression is performed by either selecting data at equidistant intervals from the training data rearranged in order of magnitude, or by dividing the training data into a plurality of segments and taking average values of the segments.

According to another aspect of the present disclosure, there is provided a method for assessing false alarm for optimizing early warning operation, the method including: (a) selecting, by a data acquisition unit, historical data stored in a database among operation data of a constant electric power facility according to selection of a multivariate input tag measured in the electric power facility; (b) generating, by a recommendation unit, learning data, which is a multivariate signal for machine learning, based on a preset similarity from the historical data; (c) compressing, by a compression unit, the learning data to generate resampling data; (d) performing, by a learning unit, real-time monitoring by using the resampling data as input data of a pre-designed early warning learning model; and (e) generating, by a calculation unit, a final warning when a condition defined through the real-time monitoring is satisfied.

The step (e) may include (e-1) monitoring a residual value that is a difference between a predicted value calculated by the early warning learning model and an actual value by the calculation unit; and (e-2) calculating a final residual value by primarily filtering the residual value by the calculation unit, and generating the final warning by using the final residual value.

In addition, step (e-2) may include the steps of: assessing, by the calculation unit, an alarm grade according to a predefined strength condition and a predefined continuity condition when the filtered residual value becomes greater than or equal to a preset threshold value and an alarm occurs; and generating, by the calculation unit, only the alarm equal to or greater than the strength condition and the continuity condition as the final alarm.

The step (e) may include generating an alarm code when the calculation unit satisfies the condition of the strength and the condition of the continuity, and generating a rule for determining a severity grade based on the alarm code.

In addition, step (e) may include a step of determining whether the calculation unit corresponds to a rule modification condition set in advance and newly writing or modifying the rule according to the determination result.

In addition, step (c) may include extracting the re-sampling data by compressing the learning data by the calculation unit in a scaling down or equidistant intervals.

### Advantageous Effects

According to an effect of the present invention, the size of data in a normal state of training data, which is the most important for prediction performance in early warning technology, is reduced, thereby improving the speed of the most frequently occurring calculation process (calculation of a predicted value).

In addition, another effect of the present invention is to monitor the residual between the measured value and the predicted value through a learning model constructed based on compressed data, and at this time, the first filtering for preventing an alarm is performed by applying the smoothing technique to a signal exceeding a set threshold, and through this, it is possible to prevent erroneous detection caused by an error occurring during sensor measurement or an abnormal signal occurring instantaneously such as spike generated during facility operation.

In addition, another effect of the present invention is that the first filtered residual signal introduces the concept of strength and continuity to re-assess the generated alarm, observes the frequency (continuity) of continuously generating multiple (intensity) of the threshold, changes the frequency (continuity) to alarm code and time (color) information, and delivers the changed alarm to the user, and helps the user to easily determine which alarm should be continuously monitored or taken through the transmitted alarm code and color.

In addition, another effect device of the present invention is that the previously transmitted alarm code may allow a user to set a rule for each equipment to detect an abnormality in the corresponding equipment, may classify the severity into grades by using the correlation of signals, and the developed rules may be an effective method for maximizing the efficiency of monitoring work because the alarm according to the severity is generated only when the rule is satisfied without the need to monitor all alarms even if a plurality of alarms are generated in the early warning.

### DESCRIPTION OF DRAWINGS

FIG. 1 is a block diagram of a system for assessing false alarm to optimize early waring operations according to an embodiment of the present invention.

FIG. 2 is a detailed block diagram of the calculation unit shown in FIG. 1.

FIG. 3 is a flowchart illustrating a process of optimizing an early warning operation according to an embodiment of the present invention.

FIG. 4 is a flowchart illustrating a process of modifying a rule after the early warning algorithm learning step illustrated in FIG. 3.

FIG. 5 is a graph illustrating a scaling-down example.

FIG. 6 is a graph showing a magnitude rearrangement for an original signal according to an embodiment of the present invention.

FIG. 7 is a graph showing a comparison between an original signal and a compressed signal according to an embodiment of the present invention.

FIG. 8 is a conceptual diagram of false alarm filtering through general smoothing technique.

FIG. 9 is a conceptual diagram illustrating strength and continuity-based assessment according to an embodiment of the present invention.

FIG. 10 is a graph showing a multivariate signal compression embodiment according to an embodiment of the present invention.

FIG. 11 is a diagram illustrating an alarm filtering embodiment 1 through residual smoothing according to an embodiment of the present invention.

FIG. 12 is a second embodiment of alarm filtering through residual smoothing according to an embodiment of the present invention.

FIG. 13 is a third embodiment of alarm filtering through residual smoothing according to an embodiment of the present invention.

FIG. 14 is a graph showing alarm generation through strength and continuity-based assessment according to an embodiment of the present invention.

FIG. 15 is a program code for generating a severity grade determination rule according to an embodiment of the present invention.

FIG. 16 is a graph showing installation and operation of a private power generation company according to an embodiment of the present invention.

### MODE FOR INVENTION

Since the present invention may make various changes and have various embodiments, specific embodiments will be illustrated in the drawings and described in detail in the detailed description. However, this is not intended to limit the present invention to specific embodiments, and it should be understood that the present invention includes all modifications, equivalents, and substitutes included in the spirit and technical scope of the present invention.

Like reference numerals are used for like elements while describing each drawing.

The terms “first”, “second”, and the like may be used to describe various elements, but the elements should not be limited by the terms. The terms are used only for the purpose of distinguishing one element from another element.

For example, without departing from the scope of the present disclosure, a first component may be referred to as a second component, and similarly, a second component may also be referred to as a first component. The term “and/or” includes a combination of a plurality of related described items or any of a plurality of related described items.

Unless otherwise defined, all terms used herein, including technical or scientific terms, have the same meaning as those generally understood by those of ordinary skill in the art to which the present invention pertains.

Terms such as those defined in commonly used dictionaries should be interpreted as having a meaning consistent with the meaning in the context of the related art, and should not be interpreted as an ideal or excessively formal meaning unless explicitly defined in the present application.

Hereinafter, a system and a method for assessing false alarm for optimizing early warning operation according to an embodiment of the present invention will be described in detail with reference to the accompanying drawings.

Early warning technology is a technology that detects early the trend of a signal changing to an abnormal state outside the trained normal section after learning the normal state pattern of the signal group.

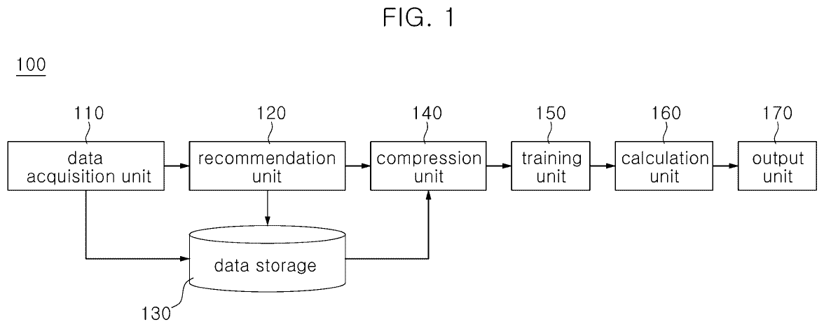

FIG. 1 is a block diagram of a system 100 for assessing false alarm to optimize early waring operations according to an embodiment of the present invention. Referring to FIG. 1, the false alarm assessment system 100 may include a data acquisition unit 110, a recommendation unit 120, a data storage 130, a compression unit 140, a training unit 150, a calculation unit 160, a display unit 170, and the like.

The data acquisition unit 110 performs a function of acquiring operation data of an electric power facility and history data using the operation data. In addition, the data acquisition unit 110 performs a function of selecting historical data input by selecting a multivariate input tag.

The data acquisition unit 110 acquires data generated through a sensor, a measuring instrument, or the like installed in the field of the electric power facility. Of course, the data acquisition unit 110 may be connected to sensors and measuring instruments through a communication network (not shown) to acquire data, or may be directly connected to the sensors. To this end, the data acquisition unit 110 may include a communication modem, a memory, and the like.

The communication network refers to a connection structure capable of exchanging information between respective nodes such as a plurality of terminals and servers, and may be a public switched telephone network (PSTN), a public switched data network (PSDN), an Integrated Services Digital Networks (ISDN), a Broadband ISDN (BISDN), a Local Area Network (LAN), a Metropolitan Area Network (MAN), a Wide LAN (WLAN), and the like.

However, the present invention is not limited thereto, and may be a wireless communication network such as a code division multiple access (CDMA), a wideband code division multiple access (WCDMA), a wireless broadband (Wibro), a wireless fidelity (WiFi), a high speed downlink packet access (HSDPA) network, a bluetooth, a near field communication (NFC) network, a satellite broadcasting network, an analog broadcasting network, a digital multimedia broadcasting (DMB) network, and the like. Alternatively, it may be a combination of these wired communication networks and wireless communication networks.

Power generation facilities include a generator that generates electricity, an electric line for supplying generated electricity, a control device that controls the generator, and facilities up to the secondary terminal of the main circuit breaker among electric machinery/equipment. Of course, various sensors and measuring instruments are installed in the power generation facility to generate operation data.

The recommendation unit 120 performs a function of recommending learning data based on similarity from the history data. In other words, it performs a function of generating learning data for learning based on similarity by acquiring historical data from the data acquisition unit 110 and/or the data storage 130.

The data storage 130 performs a function of storing driving data, history data, training data generated through the recommendation unit 120, and the like obtained through the data acquisition unit 110. To this end, the data storage 130 may include at least one storage medium of a flash memory type, a hard disk type, a multimedia card micro type, a card type memory (e.g., a secure digital (SD) or an eXtreme digital (XD) memory), a Random Access Memory (RAM), a static random access memory (SRAM), a Read Only Memory (ROM), an electrically erasable programmable read only memory (EEPROM), a programmable read only memory (PROM), a magnetic memory, a magnetic disk, and an optical disk.

In addition, it may operate in relation to a web storage or a cloud server that performs a storage function on the Internet.

The compression unit 140 performs a function of generating re-sampling data by compressing training data, which is a multivariate signal, according to a multivariate input tag.

The training unit 150 performs a function of performing real-time monitoring by using the resampling data as input data of the early warning training model. In other words, it performs a function of monitoring a residual value, which is the difference between the predicted value and the actual value calculated through the early warning learning model.

The early warning learning model will be described as follows. AAKR predicts the state of the system by comparing past data (≈training data or memory vector) indicating the normal state with measurement data (≈test data). When the training data is defined as X, Xi,j represents the i-th data of the j sensor. The form of X is as follows.

$$X = [ \begin{matrix}{X}_{1 , 1} & {X}_{1 , 2} & … & {X}_{1 , P} \\ {X}_{2 , 1} & {X}_{2 , 2} & … & {X}_{2 , P} \\ ⋮ & ⋮ & ⋱ & ⋮ \\ {X}_{{n}_{m} , 1} & {X}_{{n}_{m} , 1} & … & {X}_{{n}_{m} , P}\end{matrix} ] \qquad Equation 1$$

Similarly, the test data can be expressed as the following equation.

$$x = [ \begin{matrix}{x}_{1} & {x}_{2} & … & {x}_{p}\end{matrix} ] \qquad Equation 2$$

The mathematical modeling method of AAKR consists of three steps. The first is to calculate the distance between the training data and the test data. There are many functions defining the distance, but this algorithm uses the commonly used Euclidean distance. The distance between the i-th training data X and the test data x is defined by the formula shown in Equation 3.

$${d}_{i} ( {X}_{i} , x ) = \sqrt{{( {X}_{i , 1} - {x}_{1} )}^{2} + {( {X}_{i , 2} - {x}_{2} )}^{2} + … {( {X}_{i , p} - {x}_{p} )}^{2}} \qquad Equation 3$$

The distance matrix d obtained by calculating the distances of the training data and the test data is defined as Equation (4).

$$d = [ \begin{matrix}{d}_{1} \\ {d}_{2} \\ ⋮ \\ {d}_{{n}_{m}}\end{matrix} ] \qquad Equation 4$$

Next, a Gaussian kernel function is applied to determine the weight of how much influence it has on the system based on the size of the distance matrices, and the form is shown in Equation (5).

$$w = {K}_{h} ( d ) = \frac{1}{\sqrt{2 π {h}^{2}}} {e}^{- {d}^{2} / {h}^{2}} \qquad Equation 5$$

Here, h is the width of the kernel, and w is a weight vector.

The calculation unit 160 performs a function of generating a final alarm using the filtered residual value by filtering the residual value. In other words, the generated alarm is primarily filtered by applying a smoothing technique to the residual value (i.e., the signal tag). When an alarm is generated because the first filtered residual is greater than or equal to a set threshold, an alarm class is assessed according to a defined strength and continuity condition, and then only an alarm equal to or greater than the defined condition is generated as a final alarm.

The output unit 170 performs a function of outputting a final alert. The final alert may be a combination of voice, graphics, and characters. To this end, the output unit 170 may include a display, a sound system, and the like. The display may be a liquid crystal display (LCD), a light emitting diode (LED) display, a plasma display panel (PDP), an organic LED (OLED) display, a touch screen, a cathode ray tube (CRT), a flexible display, a micro LED, a mini LED, or the like. The touch screen may be used not only as an output means but also as an input means.

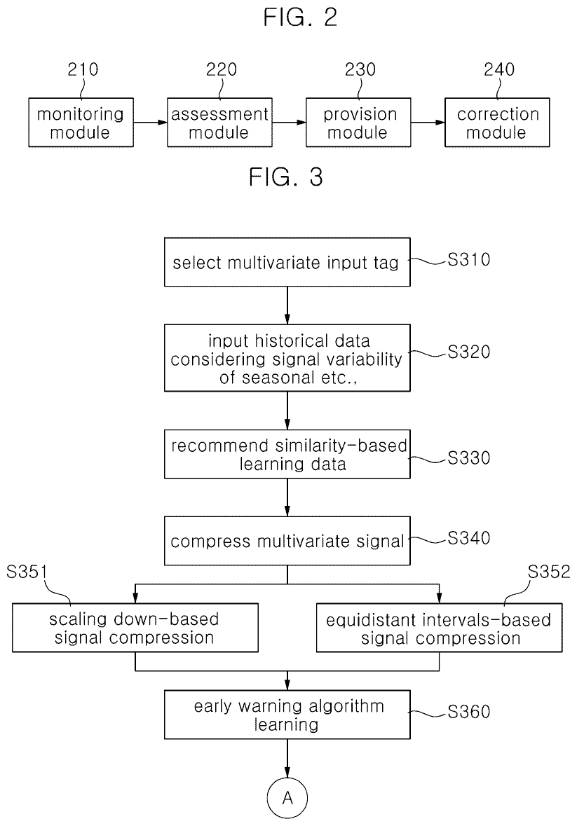

FIG. 2 is a detailed block diagram of the calculation unit 160 shown in FIG. 1. Referring to FIG. 2, the calculation unit 160 may include a monitoring module 210 for monitoring a residual value that is a difference between a predicted value calculated through an early warning learning model and an actual value, an assessment module 220 for primarily filtering a residual generated by applying a smoothing technique (i.e., a smoothing algorithm) and rating an alarm grade according to conditions of strength and continuity with respect to the filtered residual, a provision module 230 for determining alarm and severity information according to the alarm grade and providing an alarm, and a correction module 240 for correcting the alarm condition (i.e., an alarm rule).

The smoothing technique (i.e., smoothing algorithm) refers to making an approximation by removing noise or fine structures to find important patterns in data. Smoothing uses many different algorithms. The most commonly used algorithm is the “moving average,” which is used to find important considerations from repeated statistical surveys.

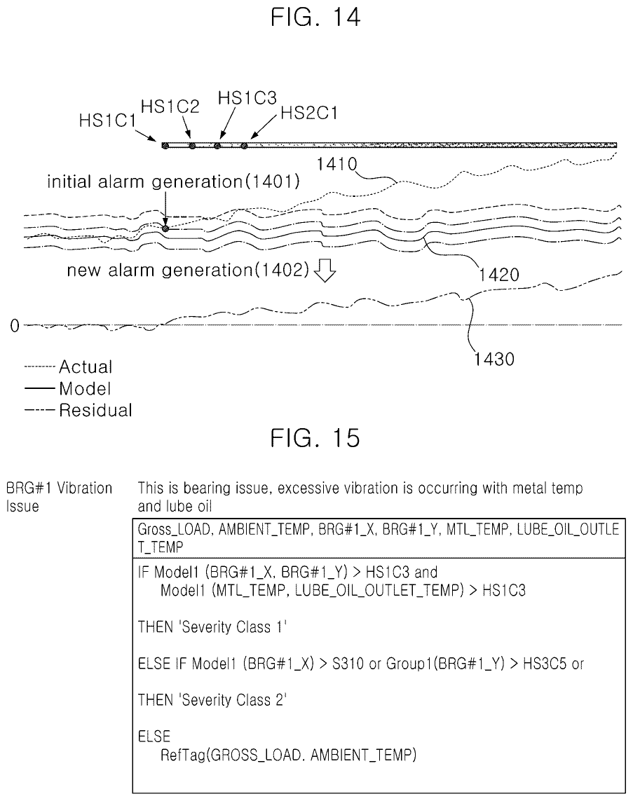

The intensity increases as the slope increases to the extent to which the actual value rises (or falls). Continuity is an indicator of how long it lasts at the same intensity. When the same strength is maintained, the continuity (C) increases. A drawing showing this is FIG. 14, which will be described later.

The “module” illustrated in FIG. 2 refers to a unit for processing at least one function or operation, which may be implemented in software and/or hardware. In the hardware implementation, it may be implemented as an application specific integrated circuit (ASIC), a digital signal processing (DSP), a programmable logic device (PLD), a field programmable gate array (FPGA), a processor, a microprocessor, another electronic unit, or a combination thereof designed to perform the above-described functions.

In software implementations, software components (elements), object-oriented software components, class components, and task components, processes, functions, attributes, procedures, subroutines, segments of program code, drivers, firmware, microcode, data, databases, data structures, tables, arrangements, and variables can be included. Software, data, and the like may be stored in a memory and executed by a processor. A memory or a processor may employ various means well known to those skilled in the art.

FIG. 3 is a flowchart illustrating a process of optimizing an early warning operation according to an embodiment of the present invention. Referring to FIG. 3, after the data acquisition unit 110 selects a multivariate input tag, the data acquisition unit 110 inputs historical data considering signal variabilities, such as before and after maintenance of electric power facilities, starts and stops, seasonal changes, changes of operating conditions, and etc. (steps S310 and S320).

The multivariate input tag refers to all signals measured in an electric power facility, such as temperature, pressure, flow rate, differential pressure, sound level, vibration, current, and voltage, and all of the scales of the signals may be used as different data input tags. The history data refers to all past data stored in a real time database (RTDB) among operation data of an electric power facility. Inquiry of the period means that data of a specific section to be used for learning among past data is retrieved. At this time, the loaded data calls a data section having the same time for the multivariate input tag.

Thereafter, the recommendation unit 120 recommends similarity-based learning data for the selected history data that is a multivariate signal (step S330).

The compression unit 140 extracts resampled data by compressing the recommended training data in a scaling down or equidistant intervals (steps S340, S351, and S352).

Thereafter, the learning unit 150 performs real-time monitoring by using the sampling data as input data of the early warning learning model (step S360).

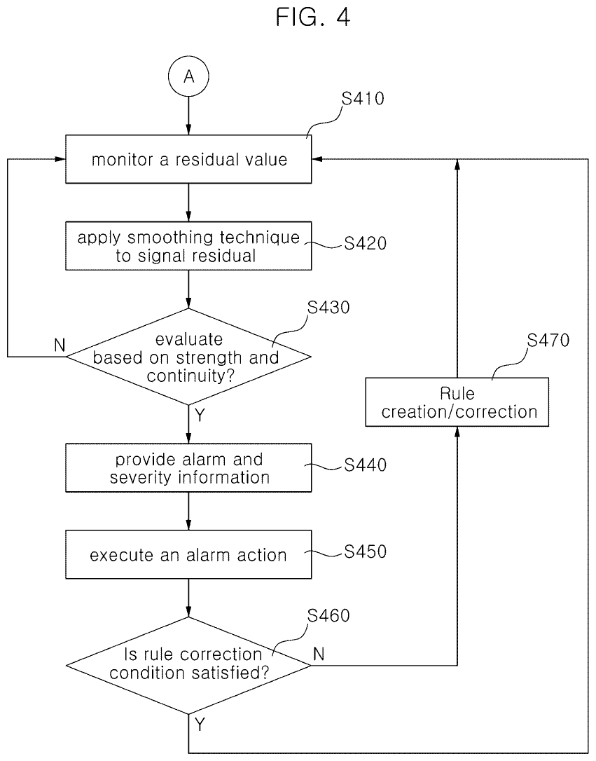

FIG. 4 is a flowchart illustrating a process of modifying a rule after the early warning algorithm learning step illustrated in FIG. 3. Referring to FIG. 4, the learning unit 150 monitors a residual value, which is a difference between a predicted value and an actual value calculated through an early warning learning model, applies a smoothing technique to the residual value, and performs primary filtering to generate a filtered final residual value (steps S410 and S420).

The primary filtering is to apply a smoothing technique to the residual, and when the size is instantaneously increased or a disturbance occurs due to an external impact signal, the signal is prevented from being distorted, thereby reducing the effect on the trend change. It functions to primarily filter out unnecessarily occurring alarms through smoothing.

Hereafter, the alarm corresponding to the final residual value is assessed based on the strength and continuity (step S430).

Thereafter, the alarm and the severity are assessed and then information on the assessed alarm and the assessed severity is provided to execute an alarm action (steps S440 and S450).

Thereafter, it is determined whether the rule correction condition is satisfied (step S460). In addition, as shown in FIG. 15, the condition in which the rule is modified assesses the alarm according to the existing rule condition, and at this time, if a signal having a high similarity is clearly identified through correlation analysis (repeatedly found through a plurality of cases), a signal having a high similarity may be added to the rule condition.

Alternatively, if it is determined that the equipment defect found through a number of cases is not a big problem or has a problem at a high level, the assessment grade of the alarm may be adjusted by raising or lowering the grade of severity.

In step S460, if the rule modification condition is not satisfied, steps S410 to S460 are performed again.

Alternatively, in step S460, if the rule correction condition is satisfied, rule creation or correction is performed (step S470). Thereafter, steps S410 to S460 are performed again.

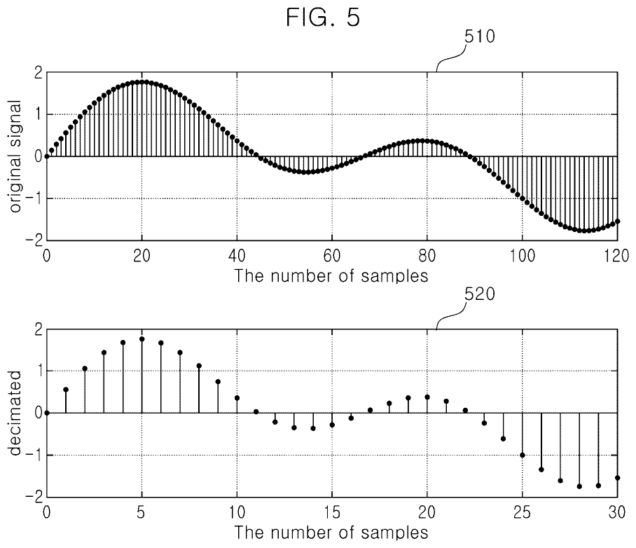

FIG. 5 is a graph illustrating a scaling-down example. Referring to FIG. 5, in the early warning, training data is a very important factor that determines the predictive performance of a training model. The training data (or memory vector) input to generate the training model refers to data extracted from a past history having a signal pattern of a normal driving state.

In the case of a complex process composed of a plurality of facilities such as a power plant, various variables and noise are mixed throughout the signal, so it is necessary to filter out abnormal signals well through signal preprocessing. In addition, since a plurality of power facilities must be monitored at the same time, as the size of the training data that the system should store is reduced to a minimum, stable and long-term operation is possible.

In addition, in Korea, where the four seasons are distinct, the outdoor air conditions and output (load) conditions vary due to seasonal effects, so the operating state of the facility also has a pattern that changes accordingly.

It is very important to extract the training data so that this pattern, that is, the trend change of the signal, can be well reflected. Accordingly, in an embodiment of the present invention, the training data is compressed and stored by resampling 520 the signal by scaling down the size of the adjacent similar data or equidistant intervals while preserving the change in the trend from the multivariate complex original signal 510.

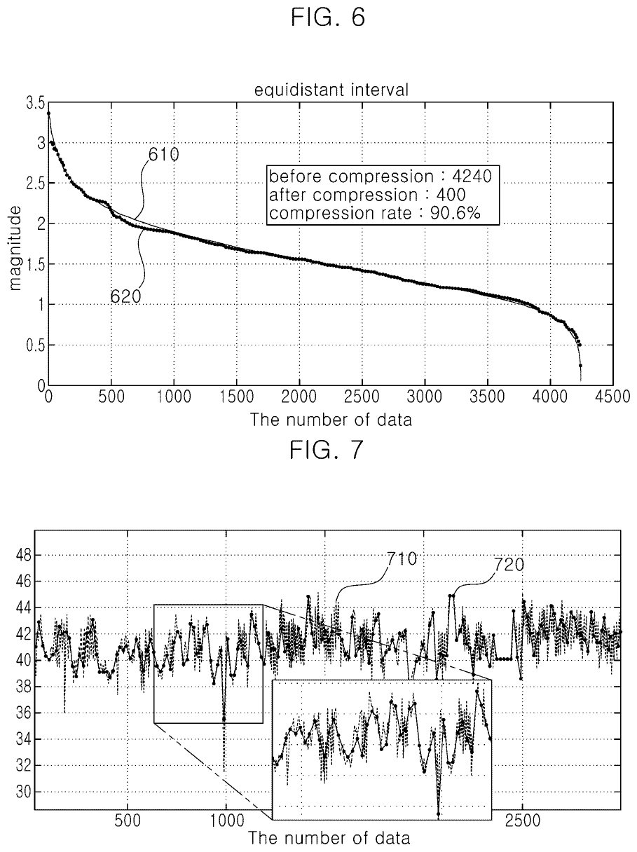

FIG. 6 is a graph showing a magnitude rearrangement for an original signal according to an embodiment of the present invention. Referring to FIG. 6, original data 610 is rearranged in order of magnitude. The more adjacent data 620 is, the higher the density of the rearranged data is, and the less adjacent data is, the lower the density is distributed.

The overall trend of the data is expressed as a curve of the graph, and if the curve of the graph is preserved, information about the trend is not lost. It is a method of compressing the original data by selecting data at equidistant intervals for the rearranged data, dividing the segments into several, and taking the average value of each segment.

FIG. 7 is a graph showing a comparison between an original signal and a compressed signal according to an embodiment of the present invention. Referring to FIG. 7, the original vector signal 710 and the compressed vector signal 720 are illustrated, and it can be seen that the compressed vector signal has a small variation width.

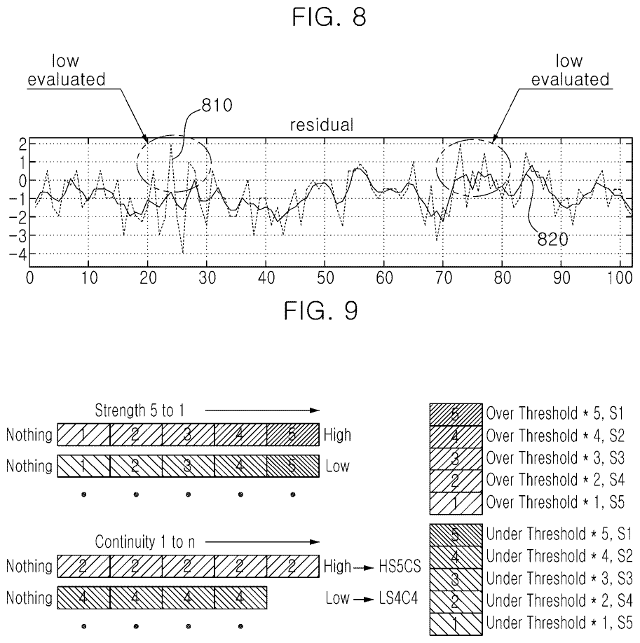

FIG. 8 is a conceptual diagram of false alarm filtering through general smoothing. Referring to FIG. 8, the smoothing technique used in an embodiment of the present invention uses an average value calculated by continuously moving a specific size data interval for a residual. The average value calculated by moving an interval of a specific size can know the flow of the average value, that is, the trend.

In addition, by calculating a partial average with surrounding data for an outlier, which is an observation value that deviates from the overall pattern, the influence of a false alarm such as a measurement error of a sensor may be reduced.

As shown in FIG. 8, when the smoothing technique is applied to a signal 810 such as a hunting that fluctuates up and down, a false alarm due to false signal analysis may be prevented in advance by performing a low assessment 820.

FIG. 9 is a conceptual diagram illustrating strength and continuity-based assessment according to an embodiment of the present invention. The early warning algorithm calculates a predicted value for new data (actual value) input in real time after constructing a learning model using the scaled-down learning data frame. A residual value, which is the difference between the calculated predicted value and the measured value, is output for each observation value. The output residual is subjected to a primary filter process through smoothing to prevent false detection.

Thereafter, as shown in FIG. 9, it is re-assessed once again based on strength and continuity. The strength condition is an assessment criterion for how many times or more the preset threshold is exceeded, and the continuity condition is a criterion for assessing how many times or more of the data observed in real time has exceeded the same strength grade (multiple of the same threshold). The assessment result for strength and continuity is converted into a code and finally marked as an alarm.

The threshold is divided into a positive direction and a negative direction, and the positive direction means a threshold for a residual in which the value of (actual value-predicted value) is upward. The negative direction means the threshold of the residual in which the value of (actual value-predicted value) is downward to the right.

Strength and continuity are graded according to steps and times in color so that users can distinguish them into visual information without interpreting code. Each grade is represented in 5 stages (S1, S2, S3, S4, S5), and the higher the intensity, the darker the color is in red, and the higher the continuity, the darker the color is in blue. This result is colored on a surveillance chart when an alarm is generated.

Based on the above technology, for example, the code of the alarm generated when the threshold is exceeded in the positive direction, the intensity of 3 grade (3 times the threshold), and the number of observations 4 times becomes ‘HS3C4’.

The alarm code developed as described above may be used as a criterion for developing a rule for detecting an abnormality with respect to a facility defect. For example, when the residual value of the tag ‘AAAA’ and the tag ‘BBBB’ of the learning model ‘A’ becomes ‘HS3C4’ in consideration of the correlation between the signals in the learning model called ‘A’, the severity is assessed as the first grade, and the alarm event is marked as ‘severity class 1’ to provide information on the priority of the actual alarm. Therefore, it helps the user (facility operation) to make quick and accurate decisions.

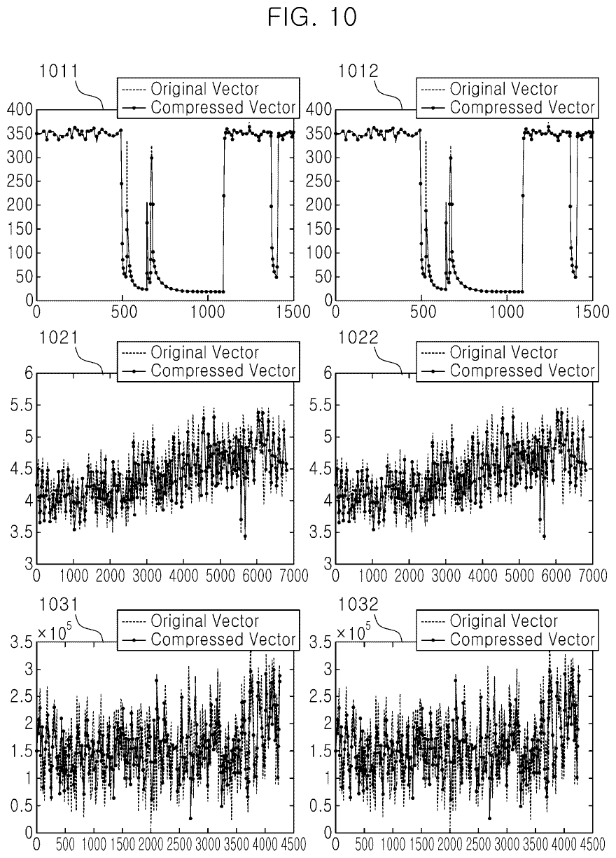

FIG. 10 is a graph showing a multivariate signal compression embodiment according to an embodiment of the present invention. Referring to FIG. 10, three examples 1011, 1012, 1021, 1022, 1031, and 1032 show an embodiment of the principles of the invention described above. The signal used was used by extracting the actual power plant operation data, and the training data was compressed by resampling down described above for each case and compared with the original signal.

In other words, the original data is compressed by selecting data at equidistant intervals (graph left) for the rearranged data, dividing the segments into several segments, and taking the average value of each segment (graph right).

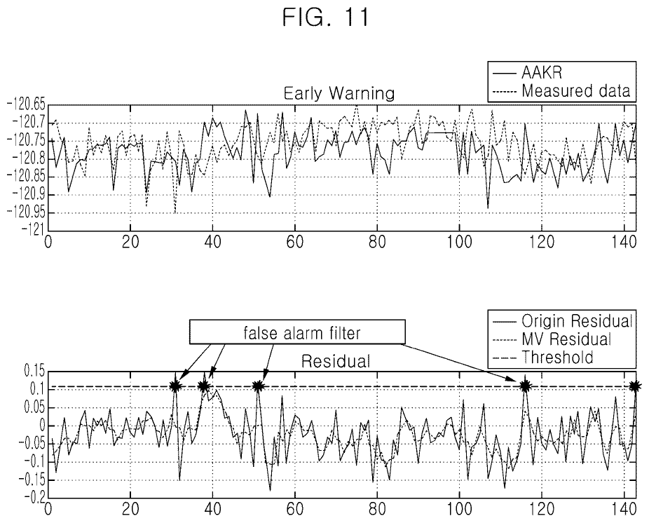

FIG. 11 is a diagram illustrating an alarm filtering embodiment 1 through residual smoothing according to an embodiment of the present invention. Referring to FIG. 11, in the case of Example 1, an original residual is a case in which an alarm is generated at five places. When the smoothing technique is applied to this case, it may be confirmed that the alarm does not occur by applying the arithmetic average value using the previous data of the alarm generation point. AAKR is an abbreviation for Auto-Associative Kernel Regression.

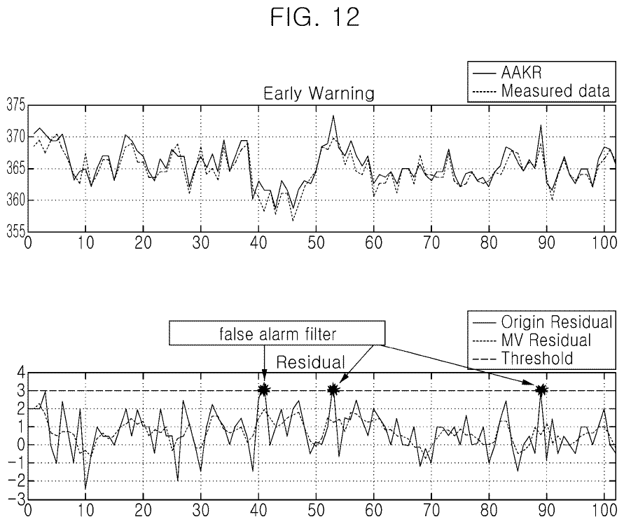

FIG. 12 is a second embodiment of alarm filtering through residual smoothing according to an embodiment of the present invention. Referring to FIG. 12, in the case of Example 2, a large difference between the predicted value and the actual value occurred in the original residual, so that false alarms appeared in three places, but it can be confirmed that no alarm occurred by applying a smoothing technique.

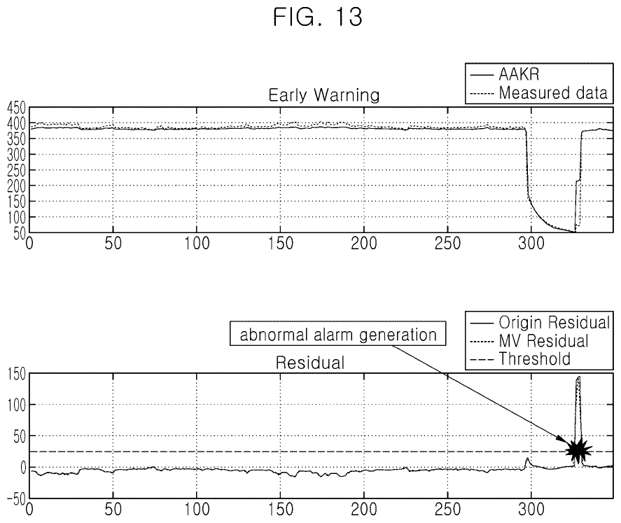

FIG. 13 is a third embodiment of alarm filtering through residual smoothing according to an embodiment of the present invention. Referring to FIG. 13, in the case of the third embodiment, it can be seen that a large difference between the predicted value and the actual value occurs due to actual facility startup in the original residual. For this reason, an abnormal alarm, that is, a valid alarm, was generated in the original residual, and in the same manner, in the residual signal using the smoothing technique, the residual is increased from the time before the occurrence, and it can be seen that an effective alarm, which is an abnormal alarm, is actually generated at that time.

FIG. 14 is a graph showing alarm generation through strength and continuity-based assessment according to an embodiment of the present invention. Referring to FIG. 14, the residual value 1430 is gradually increased due to deterioration of the facility after the initial alarm 1401 is generated. When given, the residual value 1430 is a value obtained by subtracting the predicted value 1420 calculated by the early warning learning model from the actual value 1410.

When the residual value is increased (positive direction), alarms of (intensity 1, continuous 1 time), (intensity 1, continuous 2), and (intensity 1, continuous 3) are generated at intervals of 10 minutes, and a new alarm 1402 is generated at 40 minutes (intensity 2, continuous 1). Since the residual value continues to rise afterwards, it is assessed for high intensity and continuity and converted into an alarm code.

A rule may be developed based on a failure mechanism between signals (tags) based on several alarm codes generated above. A program code showing this is shown in FIG. 15.

FIG. 15 is a program code for generating a severity grade determination rule according to an embodiment of the present invention. Referring to FIG. 15, the rules developed in this way are expressed as severity by dividing grades. The expressed severity is displayed in the alarm & event log and is used as important information for the user to determine the facility name, alarm location, and importance of the alarm only with event information.

FIG. 15 is an example of a program code in which a bearing issue occurs, and when an excess variation occurs due to a metal temperature and a lubrication oil, severity is defined as class 1 and class 2 grades.

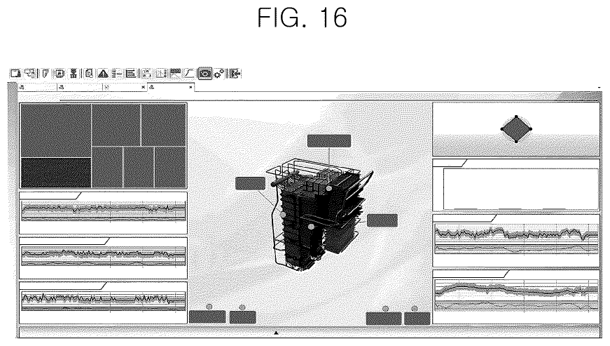

FIG. 16 is a graph showing installation and operation of a private power generation company according to an embodiment of the present invention. Referring to FIG. 16, the early warning technology is a technology based on artificial intelligence and big data, which has recently been in the spotlight in relation to the field of intelligent digital development, and the latest leading technology is applied, and this technology is entering the ‘TRL(9): commercialization’ stage from the ‘TRL(8): prototype authentication and standardization’ stage, so it is expected that it may be used for a considerable period of time when it is introduced in the field.

In addition, related technologies are gradually being introduced into the market for domestic and foreign power plants, and the early warning technology of the present invention can be used not only in the field of power generation but also in all mechanical systems, and thus can be extended to other industrial fields such as defense, chemical/oil refinery plants, large ships, and wind power generation.

In addition, the steps of the method or algorithm described in connection with the embodiments disclosed herein may be implemented in the form of program instructions that may be executed through various computer means such as a microprocessor, a processor, a Central Processing Unit (CPU), and the like, and recorded in a computer-readable medium. The computer-readable medium may include a program (command) code, a data file, a data structure, and the like alone or in combination.

The program (command) code recorded in the medium may be specially designed and configured for the present invention or may be known to and available to those skilled in the computer software. Examples of the computer-readable recording medium may include magnetic media such as a hard disk, a floppy disk, and a magnetic tape, optical media such as a CD-ROM, a DVD, and a Blu-ray, and a semiconductor memory device specially configured to store and execute program (command) codes such as a Read Only Memory (ROM), a Random Access Memory (RAM), and a flash memory.

Examples of the program (command) code include not only machine language code generated by a compiler, but also high-level language code that may be executed by a computer using an interpreter or the like. The hardware device described above may be configured to operate as one or more software modules to perform the operations of the present invention, and vice versa.

1. A system for assessing false alarm to optimize early waring operations, the system comprising:
a data acquisition unit (110) for selecting and acquiring historical data stored in a database among operation data of a constant electric power facility according to selection of a multivariate input tag measured in the electric power facility;
a recommendation unit (120) for generating training data, which is a multivariate signal for machine learning, based on a preset similarity from the historical data;
a compression unit (140) for generating re-sampling data by compressing the training data; a training unit (150) for performing real-time monitoring by using the re-sampling data as input data of a pre-designed early warning training model; and
a calculation unit (160) for generating a final warning when a condition defined in advance through the real-time monitoring is satisfied.

2. The system of claim 1, wherein the calculation unit 160 monitors a residual value that is a difference between a predicted value calculated through the early warning learning model and an actual value, and calculates a final residual value by primarily filtering the residual value, and generates the final warning using the final residual value.

3. The system of claim 2, wherein the calculation unit 160 assesses an alarm grade according to a predefined strength condition and a predefined continuity condition of the defined condition when the filtered residual value becomes greater than or equal to a predetermined threshold value, and generates only an alarm equal to or greater than the predetermined condition as the final alarm.

4. The system of claim 3, wherein the strength condition is a criterion for assessing how many times or more the preset threshold is exceeded, and the continuity condition is a criterion for assessing how many times or more of the data observed in real time exceeds the same strength grade (multiple of the same threshold).

5. The system of claim 3, wherein the calculation unit 160 generates an alarm code when the condition of the intensity and the condition of the continuity are satisfied, and generates a rule for determining a severity grade based on the alarm code.

6. The system of claim 5, wherein the calculation unit 160 determines whether the rule corresponds to a preset rule correction condition and newly creates or corrects the rule according to the determination result.

7. The system of claim 2, wherein the calculation unit 160 extracts the re-sampling data by compressing the training data to a scaling down or equidistant intervals.

8. The system of claim 7, wherein the compression is performed by either selecting data at equidistant intervals from the training data rearranged in order of magnitude, or by dividing the training data into a plurality of segments and taking average values of the segments.

9. A method for assessing false alarm to optimize early waring operations, the method comprising:
(a) selecting and acquiring, by a data acquisition unit (110), historical data stored in a database among operation data of a constant electric power facility according to selection of a multivariate input tag measured in the electric power facility;
(b) generating, by a recommendation unit (120), learning data which is a multivariate signal for machine learning based on a preset similarity from the historical data;
(c) compressing, by a compression unit (140), the learning data to generate re-sampling data;
(d) performing, by a learning unit (150), real-time monitoring by using the re-sampling data as input data of a pre-designed early warning learning model; and
(e) generating, by a calculation unit (160), a final warning when a condition defined through the real-time monitoring is satisfied.

10. The method of claim 9, wherein the step (e) comprises: (e-1) monitoring, by the calculation unit 160, a residual value that is a difference between a predicted value calculated through the early warning learning model and an actual value; and (e-2) calculating a final residual value by primarily filtering the residual value by the calculation unit 160, and generating the final warning using the final residual value.

11. The method of claim 10, wherein the step (e-2) comprises: assessing, by the calculation unit 160, an alarm grade according to a predefined strength condition and a predefined continuity condition of the defined condition when the filtered residual value becomes greater than or equal to a preset threshold value and thus an alarm occurs; and generating, by the calculation unit 160, only the alarm equal to or greater than the defined condition as the final alarm.

12. The method of claim 11, wherein the strength condition is a criterion for assessing how many times or more the preset threshold is exceeded, and the continuity condition is a criterion for assessing how many times or more of the data observed in real time exceeds the same strength grade (multiple of the same threshold).

13. The method of claim 11, wherein the step (e) comprises: generating, the calculation unit 160, an alarm code when the predefined strength condition and the predefined continuity condition are satisfied, and generating a rule for determining the severity grade based on the alarm code.

14. The method of claim 13, wherein the step (e) comprises: determining, by the calculation unit 160, whether the rule corresponds to a preset rule correction condition, and newly creating or correcting the rule according to the determination result.

15. The method of claim 9, wherein the step (c) comprises extracting, by the calculation unit 160, the re-sampling data by compressing the learning data in a scaling down or equidistant intervals.

16. The method of claim 15, wherein the compression is performed by either selecting data at equidistant intervals from the training data rearranged in order of magnitude, or by dividing the training data into a plurality of segments and taking average values of the segments.
